(19) United States
(12) Patent Application Publication
(10) Pub. No.: US 2006/0189209 A1
(43) Pub. Date: Aug. 24, 2006

(54) Electronic connector with fool-proof mechanism

(76) Inventor: Ming Chun Lai, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/060,413

(22) Filed: Feb. 18, 2005

(51) Int. Cl. H01R 13/648

(52) U.S. Cl. 439/607

(57) ABSTRACT

An electronic connector with fool-proof mechanism includes an insulating body and a shielded body enclosing the insulating body. At least one first block is provided in the bottom side of the insulating body and two-second blocks are provided in the topside of the insulating body. At least one first mated hole is provided in the bottom side of the shielded body and two second mated holes are provided in the topside of the shielded body. As a result, the present invention avoids the errors when the insulating body is assembled with the shielded body. Further, more than one fixed pins are projected from the top and bottom sides of the shielded body, so the present invention avoids the errors when the shielded body is assembled with the PCB. Therefore, the present invention achieves a double fool-proof effect.

### BACKGROUND OF THE INVENTION

1. Field of the Invention

The present invention relates generally to an electronic connector, and more especially to an electronic connector with fool-proof mechanism.

2. The Related Art

A common electronic connector usually includes an insulating body, a shielded body enclosing the insulating body, a plurality of terminals fixed in the insulating body. A plurality of fixed pins with same shape and size are provided in the top and bottom sides of the shielded body. The pins are soldered on the PCB (Printed Circuit Board) to assemble the electronic connector with the PCB.

In the process of assembly, firstly, a plurality of terminals are fixed in the insulating body; secondly, the insulating body is inserted into the shielded body; finally, a plurality of terminals and fixed pins are soldered on the PCB.

However, the opposite faces of the shielded body are provided of symmetrical rectangle. When assembling, the following two conditions are occurred. The insulating body is inserted in reversed direction into the shielded body; and the shielded body is fixed in reversed direction on the PCB.

Either of the above conditions results in errors when the terminals assembled with the PCB, and further results in the current is broken off and the signal is transmitted incorrectly.

### SUMMARY OF THE INVENTION

Thus, an object of the present invention is to provide an electronic connector with fool-proof mechanism, which avoids the errors and assures the quality of the products when an insulating body is assembled with a shielded body and the shielded body is assembled with the PCB.

To attain the above object, the electronic connector with fool-proof mechanism of the present invention comprises an insulating body, a shielded body enclosing the insulating body, a plurality of terminals fixed in the insulating body and a welding pin formed at the back of each terminal. At least one first block is provided in the bottom side of the insulating body and two second blocks are provided in the top side of the insulating body. At least one mated hole is provided in the bottom side of the shielded body and two second mated holes are provided in the top side of the shielded body. Further, a plurality of fixed pins are provided in the top and bottom sides of the shielded body.

The insulating body is approximately rectangular. A first block is projected from the bottom side of the insulating body. More than one second blocks are projected from the top side of the insulating body. For example, there are two second blocks. The shielded body is also approximately rectangular. Corresponding to the first block and the second blocks, a first mated hole and more than one second mated holes are respectively provided in the shielded body.

The electronic connector with fool-proof mechanism of the present invention further provides a plurality of fixed pins projected from the top and bottom sides of the shielded body and arranged in a triangular form.

The back of the first mated hole and the second mated holes of the shielded body connects with the outside. A plurality of holes formed in the both sides of the shielded body. Corresponding to the holes, a plurality of wedged blocks are projected from both sides of the insulating body to insert into the holes respectively.

As mentioned above, the pins of the terminals and the pins of the shielded body are soldered on the PCB. The first and second mated holes avoid the errors when the insulating body is assembled with the shielded body. The fixed pins avoid the errors when the shielded body is assembled with the PCB. As a result, the present invention provides a double fool-proof effect. Also, because of a plurality of fixed pins are arranged in a triangular form, the present invention provides a reliable and stable assembly.

### BRIEF DESCRIPTION OF THE DRAWINGS

FIG. 1 is an exploded perspective view of an electronic connector with fool-proof mechanism in accordance with the present invention;

FIG. 2 is an assembled perspective view of an electronic connector with fool-proof mechanism in accordance with the present invention; and

FIG. 3 is an assembled perspective view showing the connection between the electronic connector with fool-proof mechanism and the PCB.

### DETAILED DESCRIPTION OF THE PREFERRED EMBODIMENT

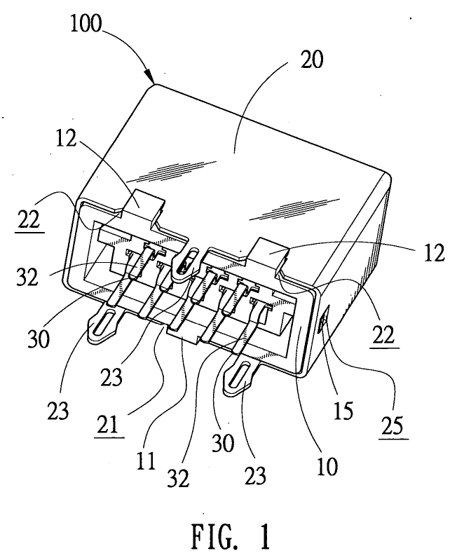

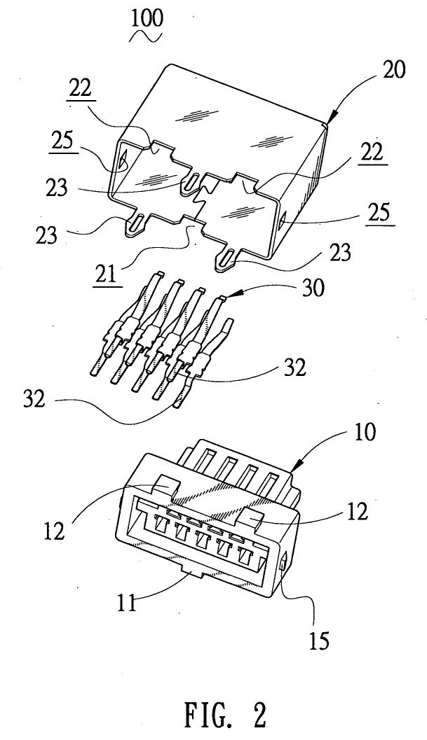

With reference to FIG. 1 and FIG. 2, an electronic connector with fool-proof mechanism, generally designed with reference numeral 100, comprises an insulating body 10, a shielded body 20 enclosing the insulating body 10, a plurality of terminals 30 fixed in the insulating body 10 and a welding pin 32 formed at the back of each terminal 30.

The insulating body 10 is approximately rectangular. A first block 11 is projected from the bottom side of the insulating body 10. More than one second blocks 12 are projected from the top side of the insulating body 10. For example, there are two second blocks 12 shown in FIG. 1. The shielded body 20 is also approximately rectangular. Corresponding to the first block 11 and the second blocks 12, a first mated hole 21 and more than one second mated holes 22 are respectively provided in the shielded body 20.

When the electronic connector with fool-proof mechanism 100 is assembled, first of all, a plurality of terminals 30 in the insulating body 10 are fixed and the welding pins 32 of the terminals 30 which are parallel each other are extended out of the insulating body 10. Then, the insulating body 10 is put into the shielded body 20. The top side of the insulating body 10 leans against the top side of the shielded body 20. The first and second blocks 11,12 of the insulating body 10 are corresponded with the first and second mated holes 21,22 of the shielded body 20 respectively. Finally, the insulating body 10 is pushed ahead so that the first and second blocks 11,12 are respectively inserted into the first and second mated holes 21,22 to make the insulating body 10 assembled with the shielded body 20 correctly.

In the process of assembly as described above, if an operator put the insulating body 10 into the shielded body 20 in reversed direction, the bottom side of the insulating body 10 leans against the top side of the shielded body 20, because the parts of the shielded body 20 corresponding to the first and second blocks 11,12 of the insulating body 10 are solid, the first and second blocks 11, 12 of the insulating body 10 can not be inserted into the first and second mated holes 21, 22 of the shielded body 20, so that the insulating body 10 can not be assembled with the shielded body 20. Therefore, the function of fool-proof for the assembling of the insulating body 10 and the shielded body 20 is achieved.

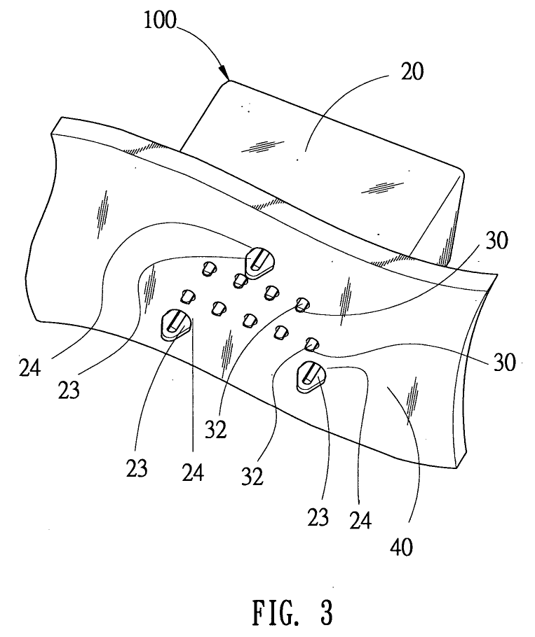

Referring now to FIG. 1 to FIG. 3, a plurality of fixed pins 23 are projected from the top and bottom sides of the shielded body 20. A printed circuit board (PCB) provides a plurality of through holes 24 so that the fixed pins 23 pass through the through holes 24 respectively and are soldered on the PCB 40.

When assembling the electronic connector with fool-proof mechanism 100 with PCB 40, the fixed pins 23 of the shielded body 20 vertically are inserted into through holes 24 of the PCB 40 and soldered in the through holes 24 of the PCB 40 in order to make the shielded body 20 and the PCB 40 assembled correctly and attain a stable installation. The welding pins 32 of a plurality of terminals 30 are soldered in the PCB 40 in order to make the electric connected.

In the process of assembly as described above, if the electronic connector with fool-proof mechanism 100 and the PCB 40 are not arranged in a correct position, the electronic connector with fool-proof mechanism 100 can not engage with the PCB 40. Therefore, the fool-proof function for assembling the electronic connector with fool-proof mechanism 100 and the PCB 40 is achieved.

Referring to FIG. 1 and FIG. 2, the electronic connector with fool-proof mechanism 100 of the present invention further provides a plurality of holes 25 formed in both sides of the shielded body 20. Corresponding to the holes 25, a plurality of wedged blocks 15 are projected from both sides of the insulating body 10 to insert into the holes 25 respectively.

In the embodiment described above, the wedged blocks 15 engage with the holes 25 respectively. The insulating body 10 is pushed ahead into the shielded body 20 and does not slide out of the shielded body 20.

Although a particular embodiment of the invention has been described in detail for purposes of illustration, additional advantages and modifications will readily appear to those skilled in the art, and various modifications and enhancements may be made without departing from the spirit and scope of the invention. Accordingly, the invention is not to be limited except as by the appended claims.

1. An electronic connector with fool-proof mechanism comprising:
an insulating body receiving a plurality of terminals, a welding pin formed at a back of each of the terminals, a first block projected from a bottom side of the insulating body and a plurality of second blocks projected from a top side of the insulating body; and
a shielded body enclosing the insulating body and providing at least one first mated hole in a bottom side of the sided body corresponding to the first block of the insulating body and a plurality of second mated holes in a top side of the shielded body corresponding to the second blocks of the insulating body, the first and second mated holes respectively engaging with the first and the second blocks, said shielded body including a plurality of fixed pins with enlarged distal ends that are projected from the shielded body for insertion into corresponding openings in a circuit board.

2-5. (canceled)

6. The electronic connector with fool-proof mechanism as claimed in claim 1, wherein a plurality of holes are formed in both sides of the shielded body; corresponding to the holes, a plurality of wedged blocks are projected from both sides of the insulating body to insert into the holes respectively.
